(19) United States
(12) Patent Application Publication
(10) Pub. No.: US 2013/0231919 A1
(43) Pub. Date: Sep. 5, 2013

(54) DISAMBIGUATING SYSTEM AND METHOD

(71) Applicants: YU-KAI XIONG, Shenzhen (CN); XIN-HUA LI, Shenzhen (CN)

(72) Inventors: YU-KAI XIONG, Shenzhen (CN); XIN-HUA LI, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/756,818

(22) Filed: Feb. 1, 2013

(30) Foreign Application Priority Data
Mar. 1, 2012 (CN) 201210051144.0

(51) Int. Cl. G06F 17/28

(52) U.S. Cl. CPC G06F 17/28
USPC 704/9

(57) ABSTRACT

A disambiguating method includes providing a storage unit storing a first database and a second database. The first database includes a dictionary of ambiguous language data, the second database includes a collection of disambiguating algorithms, each piece of ambiguous language data in the dictionary is associated with at least one of the disambiguating algorithms. A sentence input is received from the application system via the interface and recognized if the sentence comprises a piece of ambiguous language date which is defined in the dictionary. The recognized piece of ambiguous language data in the sentence is disambiguated using the at least one associated disambiguating algorithm, and results of disambiguating are generated. An interpretation is selected from the results and output to the application system via the interface. A disambiguating system is also provided.

### BACKGROUND

1. Technical Field

The present disclosure relates to language disambiguating systems and a method relating thereto.

2. Description of Related Art

When words or phrases are ambiguous, there is more than one interpretation. When translating from one language into another, there is a need to resolve any ambiguities to ensure full and correct understanding of sentences.

Therefore, it is desirable to provide a disambiguating system and method, which can overcome the above-mentioned problem.

### BRIEF DESCRIPTION OF THE DRAWINGS

FIG. 1 is a functional block diagram of a disambiguating system used in sentences according to a first embodiment.

FIG. 2 is a flowchart showing a disambiguating method implemented by the disambiguating system of FIG. 1.

### DETAILED DESCRIPTION

Embodiments of the disclosure will be described with reference to the accompanying drawings.

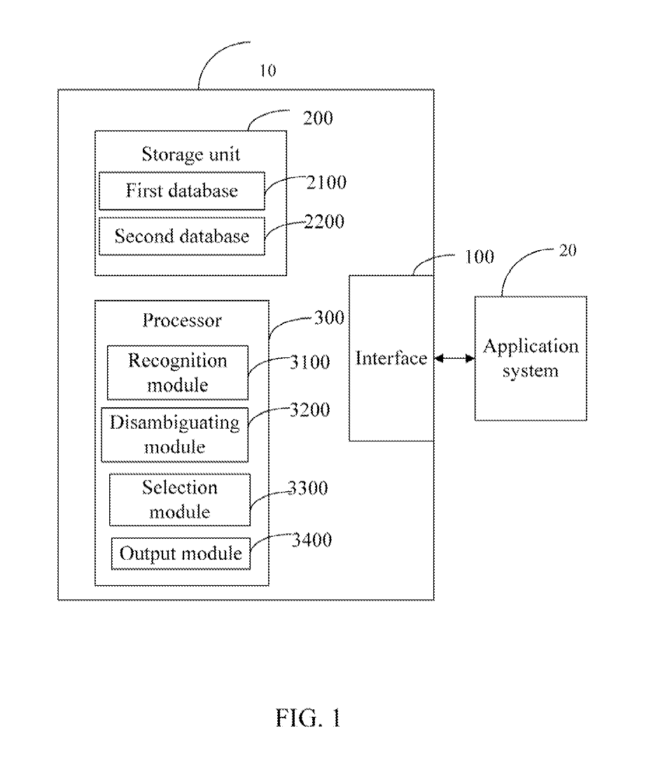

FIG. 1 shows a disambiguating system 10 in accordance with an embodiment of this disclosure. The disambiguating system 10 can be connected to an application system 20, such as a translation machine. The application system 20 has a user interface for receiving user inputs, such as sentences which need to be disambiguated. The application system 20 receives outputs from the disambiguating system 10, such as the result of disambiguating the sentences.

The disambiguating system 10 includes an interface 100, a storage unit 200, and a processor 300. The disambiguating system 10 exchanges information with the application system 20 via the interface 100. For example, the disambiguating system 10 receives sentences for disambiguation from the application system 20 via the interface 100, and the application system 20 receives outputs from the disambiguating system 10 via the interface 100.

The storage unit 200 stores a first database 2100 and a second database 2200. The first database 2100 includes a dictionary of ambiguous language data, such as ambiguous words and/or phrases. The second database 2200 includes a collection of disambiguating algorithms, such as disambiguating algorithms based on professional semantics, colloquial semantics, and context. Each piece of ambiguous language data in the dictionary is associated with at least one disambiguating algorithm.

The processor 300 includes a recognition module 3100, a disambiguating module 3200, a selection module 3300, and an output module 3400.

The recognition module 3100 receives a sentence or other input from the application system 10 via the interface and recognizes if the sentence includes a piece of ambiguous language data which is defined in the dictionary. In detail, the recognition module 3100 searches each word and phrase of the sentence, and determines whether the words and/or phrases are ambiguous. For example, the recognition module 3100 searches and finds the phrase “underground factory” in the sentence. The sentence “[T]his is an underground factory and should be banned” is ambiguous as the phrase “underground factory” is defined in the dictionary as having a special meaning, and in the sentence “I went fishing for some sea bass” the word “bass” is also ambiguous. The word “mouse” is another example of a word with more than one meaning, in the sentence “I killed a mouse this morning”.

The first database 2100 also includes distinct and different definitions of the phrase “underground factory” and the words “bass” and “mouse” in the dictionary. For example, the phrase “underground factory” has two distinct definitions: (1) an illegal factory (colloquial semantics), and (2) a factory operating below the surface of the earth. The word “bass” also has two distinct definitions: (1) a type of fish, and (2) audible tones of low frequency. The word “mouse” also has two distinct definitions: (1) small rodent, and (2) a computer input device.

The first database 2100 also associates the phrase “underground factory” with the disambiguating algorithms based on colloquial semantics and context, and the words “bass”, and “mouse,” with the disambiguating algorithms based upon professional semantics and context.

The disambiguating module 3200 is to disambiguate the recognized piece of ambiguous language date to generate results of disambiguating, using the associated disambiguating algorithm(s) of the output from the recognition module 3100. For example, the disambiguating module 3200 interprets the phrase “underground factory” as “an illegal factory” using the disambiguating algorithms based on colloquial semantics and context (the word “banned” in the context provides enough evidence to prompt disambiguation of the phrase “underground factory”). The disambiguating module 3200 interprets the word “bass” as a type of fish using the disambiguating algorithms based on professional semantics and context (the word “fishing” and “sea” in the context provide enough evidence to prompt disambiguation of the word “bass”). The disambiguating module 3200 interprets the word “mouse” as a computer input device using the disambiguating algorithms based on professional semantics and as a small rodent using disambiguating algorithm based on context (the word “killed” in the context provides evidence to prompt disambiguation of the word “mouse”).

The selection module 3300 selects an interpretation from results, using various methods such as decision tree. For example, the selection module 3300 selects “illegal factory” as the definition of the phrase “underground factory” because both the disambiguating algorithms based on colloquial semantics and context yield the same result of “illegal factory” . The selection module 3300 selects “a type of fish” as the appropriate definition of the word “bass” as both the disambiguating algorithms based on professional semantics and context result in the interpretation “a type of fish”. The selection module 3300 selects “a small rodent” instead of “a computer input device” as the interpretation of the meaning of the word “mouse” using decision tree method.

The output module 3400 outputs the interpretations.

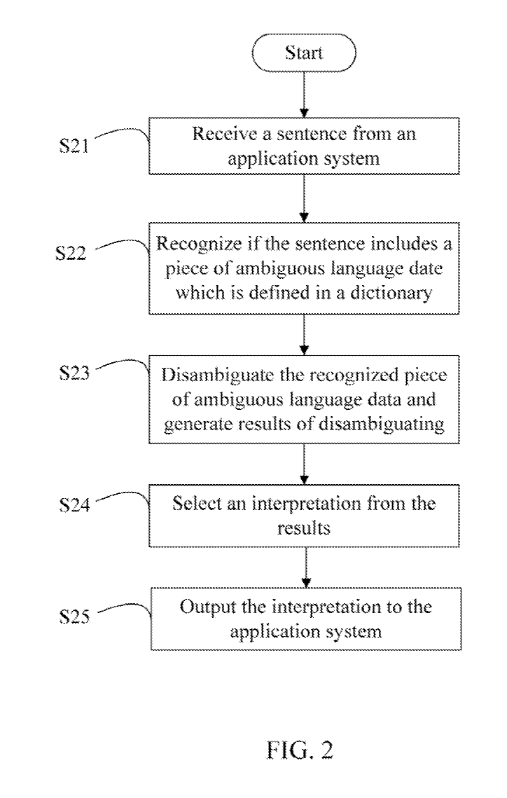

FIG. 2 is a flowchart showing a disambiguating method implemented by the disambiguating system of FIG. 1.

In step S21, the recognition module 3100 receives a sentence from the application system 10 via the interface 100.

In step S22, the recognition module 3100 recognizes if a piece of ambiguous language data which is defined in the dictionary is existed in the sentence.

In step S23, the disambiguating module 3200 disambiguates the recognized piece of ambiguous language data to produce one or more results of disambiguating, utilizing the at least one associated disambiguating algorithm, and generate results of disambiguating.

In step S24, the selection module 3300 selects an interpretation from the results.

In step S25, the output module 3400 outputs the interpretation to the application system 10 via the interface 100.

In another embodiment, the first database 2100 and the second database 2200 can be updated by a user to edit (e.g., add, change, or delete) the language data and disambiguating algorithms.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A disambiguating system, comprising:
an interface, to connect to an application system;
a storage unit, to store a first database and a second database, the first database comprising a dictionary of ambiguous language data, the second database comprising a collection of disambiguating algorithms, each piece of ambiguous language data in the dictionary being associated with at least one of the disambiguating algorithms; and
a processor comprising:
a recognition module, to receive a sentence input from the application system via the interface and recognize if the sentence comprises a piece of ambiguous language date which is defined in the dictionary;
a disambiguating module, to disambiguate the recognized piece of ambiguous language data in the sentence using the at least one associated disambiguating algorithm, and generate results of disambiguating;
a selection module, to select an interpretation from the results; and
an output module, to output the interpretations to the application system via the interface.

2. The disambiguating system according to claim 1, wherein the selection module selects an interpretation from results of the disambiguating algorithms using a decision tree method.

3. The disambiguating system according to claim 1, wherein the disambiguating algorithms are based on professional semantics, colloquial semantics, and context.

4. The disambiguating system according to claim 1, wherein the first database and the second database are allowed to be updated by a user to edit the language data and the disambiguating algorithms.

5. A disambiguating method, comprising:
providing a storage unit storing a first database and a second database, wherein the first database comprises a dictionary of ambiguous language data, the second database comprises a collection of disambiguating algorithms, each piece of ambiguous language data in the dictionary being associated with at least one of the disambiguating algorithms; and
receiving a sentence input from the application system via the interface and recognizing if the sentence comprises a piece of ambiguous language date which is defined in the dictionary;
disambiguating the recognized piece of ambiguous language data in the sentence using the at least one associated disambiguating algorithm, and generating results of disambiguating;
selecting an interpretation from the results; and
outputting the interpretations.

6. The disambiguating method according to claim 5, wherein the step of selecting an interpretation from results uses a decision tree method.

7. The disambiguating method according to claim 5, wherein the disambiguating algorithms are based on professional semantics, colloquial semantics, and context.

8. The disambiguating method according to claim 5, further comprising:
updating the first database and the second database by a user to edit the language data and the disambiguating algorithms.
